(19) United States
(12) Patent Application Publication
(10) Pub. No.: US 2002/0192537 A1
(43) Pub. Date: Dec. 19, 2002

(54) Metallic layer component for use in a direct oxidation fuel cell

(76) Inventor: Xiaoming Ren, Guilderland, NY (US)

Correspondence Address: CESARI AND MCKENNA, LLP, 88 BLACK FALCON AVENUE, BOSTON, MA, 02210, US

(21) Appl. No.: 09/882,699

(22) Filed: Jun. 15, 2001

(51) Int. Cl. H01M 4/94; H01M 8/02; H01M 8/10

(52) U.S. Cl. 429/44; 429/30; 429/34

(57) ABSTRACT

Metallic layer components for use in a direct oxidation fuel cell are disclosed. A direct oxidation fuel cell includes a membrane electrode assembly having an anode face and a cathode face. An anodic diffusion layer is associated with the anode face and a cathodic diffusion layer is associated with the cathode face. The metallic diffusion layers, in accordance with one embodiment of the invention include pores formed in the diffusion layer to allow substances to flow through the diffusion layer to the membrane electrolyte and back out again. Another embodiment of the invention incorporates metallic layer components that are formed using particle diffusion bonding techniques and are then coated with hydorphilic or hydrophobic substances to control reactant flow and transport. The metallic layers may also perform the function of flow field plates that not only direct the flow of substances to and from the membrane, but also conduct the electrons and thus the electricity generated by the cell.

### BACKGROUND OF THE INVENTION

1. Field of the Invention

This invention relates generally to direct oxidation fuel cells, and more particularly, to the diffusion layers and flow field plates of fuel cells.

2. Background Information

Fuel cells are devices in which an electrochemical reaction is used to generate electricity. A variety of materials may be suited for use as a fuel depending upon the materials chosen for the components of the cell. Organic materials, such as methanol or natural gas, are attractive choices for fuel due to the their high specific energy.

Fuel cell systems may be divided into “reformer-based” systems (i.e., those in which the fuel is processed in some fashion to extract hydrogen from the fuel before it is introduced into the fuel cell system) or “direct oxidation” systems in which the fuel is fed directly into the cell without the need for separate internal or external processing. Most currently available fuel cells are reformer-based fuel cell systems. However, because fuel-processing is expensive and requires significant volume, reformer based systems are presently limited to comparatively high power applications.

Direct oxidation fuel cell systems may be better suited for a number of applications in smaller mobile devices (e.g., mobile phones, handheld and laptop computers), as well as in some larger applications. Typically, in direct oxidation fuel cells, a carbonaceous liquid fuel in an aqueous solution (typically aqueous methanol) is applied to the anode face of a membrane electrode assembly (MEA). The MEA contains a protonically-conductive but, electronically non-conductive membrane (PCM). Typically, a catalyst which enables direct oxidation of the fuel on the anode is disposed on the surface of the PCM (or is otherwise present in the anode chamber of the fuel cell). Protons (from hydrogen found in the fuel and water molecules involved in the anodic reaction) are separated from the electrons. The protons migrate through the PCM, which is impermeable to the electrons. The electrons thus seek a different path to reunite with the protons and Oxygen molecules involved in the cathodic reaction and travel through a load, providing electrical power.

One example of a direct oxidation fuel cell system is a direct methanol fuel cell system or DMFC system. In a DMFC system, methanol in an aqueous solution is used as fuel (the “fuel mixture”), and oxygen, preferably from ambient air, is used as the oxidizing agent. There are two fundamental reactions that occur in a DMFC which allow a DMFC system to provide electricity to power consuming devices: the anodic disassociation of the methanol and water fuel mixture into CO₂, protons, and electrons; and the cathodic combination of protons, electrons and oxygen into water. The overall reaction may be limited by the failure of either of these reactions to proceed to completion at an acceptable rate (more specifically, failure to oxidize the fuel mixture will limit the cathodic generation of water, and vice versa).

As noted, the DMFC produces carbon dioxide as a result of the reaction at the anode. This carbon dioxide is separated from the remaining methanol fuel mixture before such fuel is re-circulated. Carbon dioxide may be treated as waste, and removed from the system, or used to perform work within the DMFC system, before it is vented or otherwise removed. For example, and not by way of limitation, the carbon dioxide gas can be used to passively pump liquid methanol into the fuel cell. This is disclosed in U.S. patent application Ser. No. 09/717,754, filed on Nov. 21, 2000, for a PASSIVELY PUMPED LIQUID FEED FUEL CELL SYSTEM, which is commonly owned by the assignee of the present invention, and which is incorporated by reference herein in its entirety. Another method of utilizing the carbon dioxide is described in U.S. patent application Ser. No. 09/837,831, filed on Apr. 18, 2001, for a METHOD AND APPARATUS FOR CO2-DRIVEN AIR MANAGEMENT FOR A DIRECT OXIDATION FUEL CELL SYSTEM, which discloses a method of using carbon dioxide to actively draw air to the cathode face of the protonically conductive membrane, thus ensuring that sufficient oxygen is available to continue the cathodic reaction as necessary, and to minimize energy loss from Oxygen transportation.

Fuel cells and fuel cell systems have been the subject of intensified recent development because of their ability to efficiently convert the energy in carbonaceous fuels into electric power while emitting comparatively low levels of environmentally harmful substances. The adaptation of fuel cell systems to mobile uses, however, is not straight-forward because of the technical difficulties associated with reforming most carbonaceous fuels in a simple, cost effective manner, and within acceptable form factors and volume limits. Further, a safe and efficient storage means for substantially pure hydrogen (which is a gas under the relevant operating conditions), presents a challenge because hydrogen gas must be stored at high pressure and at cryogenic temperatures or in heavy absorption matrices in order to achieve useful energy densities. It has been found, however, that a compact means for storing hydrogen is in a hydrogen rich compound with relatively weak chemical bonds, such as methanol or an aqueous methanol solution (and is to a lesser extent, ethanol, propane, butane and other carbonaceous liquids or aqueous solutions thereof).

In particular DMFCs are being developed for commercial production for use in portable electronic devices. Thus, the DMFC system, including the fuel cell, and the components may be fabricated using materials that not only optimize the electricity-generating reactions, but which are also cost effective. Furthermore, the manufacturing process associated with those materials should not be prohibitive in terms of labor intensity cost.

Typical DMFC systems include a fuel source, fluid and effluent management systems, and a direct methanol fuel cell (“fuel cell”). The fuel cell typically consists of a housing, and a membrane electrode assembly (“MEA”) disposed within the housing.

A typical MEA includes a centrally disposed protonically conductive, electronically non-conductive membrane (“PCM”). One example of a commercially available PCM is Nafion® a registered trademark of E.I. Dupont de Nours and Company, a cation exchange membrane comprised of perflourosulfonic acid, in a variety of thicknesses and equivalent weight. The PCM is typically coated on each face with an electrocatalyst such as platinum, or platinum/ruthenium mixtures or alloy particles. On either face of the catalyst coated PCM, the electrode assembly typically includes a diffusion layer. The diffusion layer functions to evenly distribute the liquid fuel mixture across the anode in the case of the fuel, or the gaseous oxygen from air or other source across the cathode face of the PCM. In addition, flow field plates are often placed on the surface of the diffusion layers which are not in contact with the coated PCM. The flow field plates function to provide mass transport of the reactants and by products of the electrochemical reactions, and they also have a current collection functionality in that the flow field plates act to collect and conduct electrons through the load.

Conventionally, the diffusion layer is fabricated of carbon paper or a carbon-cloth, typically with a porous coating made of a mixture of carbon powder and Teflon coating. However, with time, carbon paper and carbon cloth become saturated in an aqueous environment, which can compromise the transport of water, methanol, and other reactants to and from the active portion of the electrode surface. Carbon paper and carbon cloth can also break down when exposed to methanol for an extended period of time causing a decrease in performance of the fuel cell by failing to appropriately distribute the reactants to the PCM. Furthermore, carbon paper and carbon cloth are fragile and may be crushed or torn easily. This fragility and dimensional instability presents difficulty in handling the materials in a manner which is feasible for commercial volume production of DMFCs and DMFC systems, and can limit the long-term fuel cell and fuel cell system performance stability. In addition, previous DMFC designs have generally required that several layers of carbon paper be placed together to form a single diffusion layer. These diffusion layers can be difficult to work with. Carbon paper and carbon cloth may not present an even distribution of the reactant substances to the MEA, depending upon the material and treatment variances of the carbon paper or cloth.

Present diffusion layers are typically comprised of one or more sheets of porous carbon paper or carbon cloth that are between 100-500 microns thick. It is typically required that approximately 4-12 sheets of carbon paper be used to fabricate a diffusion layer for a direct methanol fuel cell. Each of these sheets of carbon paper is typically “wet-proofed” with Teflon or otherwise treated in a manner that makes the diffusion layer hydrophobic to prevent water from saturating the diffusion layer. If the diffusion layer becomes saturated, it may slow or entirely stop the transport of one or more of the reactants or byproducts to or from the PCM thus limiting the performance of the fuel cell and the fuel cell system. Furthermore, there are form factors and space constraints associated with the small hand-held devices with which the DMFCs are likely to be used, making it critical to minimize the volume of the system.

It is further noted that the use of carbon paper, carbon cloth, or other pliable materials also presents difficulties related to ensuring proper distribution of fuel through the flow field channels. For example, in a DMFC design where a flow field plate with channels are utilized, the carbon cloth or the carbon paper diffusion layer may clog or otherwise block the flow field channel, thus preventing an even distribution of the fuel mixture. This is particularly true where the fuel cell is fabricated in a manner in which pressure is applied to ensure proper contact between the various components.

Many direct methanol fuel cell systems employ an active management scheme to manage the reactants and byproducts in the direct methanol fuel cell, including pumping or otherwise causing the fuel mixture to the anodic face of the PCM. Alternatively, there may be an actively managed system which removes anodically evolved carbon dioxide from the anode face of the PCM, or which induces air to the cathode face of the PCM. To increase the utility and effectiveness of DMFC systems, there may be a need for a variety of types of diffusion layers and flow field plates. In some cases, a hydrophobic (or partially hydrophobic) diffusion layer is a useful component to assist in the control of gaseous reactants or byproducts. It may be of further advantage to utilize a hydrophilic (or partially hydrophilic) diffusion layer to assist in the control of liquid reactants or byproducts. At present, the carbon paper-based diffusion layers can be treated with hydrophobic or hydrophobic substances, but the difficulties previously outlined with respect to carbon paper and carbon cloth would exist.

There remains a need, therefore, for a diffusion layer that provides optimal diffusion properties, but that is constructed of materials that lend themselves to mass manufacturing (and installation in a DMFC on a large commercial scale), which materials are cost effective, and are dimensionally stable under the compression load and relevant operating environment over extended usage, and do not require extraordinarily delicate handling in the manufacturing process, and which may be treated to take on hydrophobic or hydrophilic qualities as needed. There remains a further need for materials that can be readily adapted to function as hydrophobic or hydrophilic in a fuel cell.

It is thus an object of the invention to provide a diffusion layer that has optimal diffusion properties and is amenable to large-scale commercial production.

It is further object of the invention to minimize or eliminate the volume of flow field plates in fuel cells and to employ a layer component that can control the flow of reactants in a manner that allows one layer to serve the purposes of both a diffusion layer and a flow field plate.

It is a further object of the invention to provide a dimensionally stable diffusion layer with controlled optimal pore distribution to enhance mass transport of reactants and byproducts of the electricity-generating reactions and ensure long term performance stability.

It is yet a further object of the invention to provide a diffusion layer that reduces the number of components and/or the weight of the cell for use in small hand held devices. It is further object to develop a robust diffusion layer that can be handled in accordance with current large-scale manufacturing techniques.

### SUMMARY OF THE INVENTION

The present invention is a versatile layer component that is substantially metallic, and which can be designed to perform the function of either a diffusion layer, or a diffusion layer combined with a flow field plate, in a direct oxidation fuel cell. In accordance with a first embodiment of the invention, the metallic layer component is manufactured using particle diffusion bonding techniques. The particles used to fabricate the layer component are metallic, and uniform in size, selected to control the pore size of the component. The anode layer component is preferably formed using of, stainless steel, titanium or other metals that do not substantially react with methanol. The cathode component is preferably fabricated of a metal selected from the group consisting of nickel, copper, steel or other suitable alloys.

Alternatively, the component may fabricated using a thin sheet of metal with pores of selected size to permit the flow of certain reactants or byproducts, while. The pores may be created using well known manufacturing techniques, MEMS fabrication techniques or a combination thereof. Regardless of the method of manufacture, the layer component of the present invention does not require the use of carbon paper or carbon cloth.

As described more fully herein, the layer component can be treated with a hydrophobic substance to make at least a portion of the component hydrophobic, or hydrophilic in nature to enhance and control the flow of gases and liquids within the fuel cell. These treatments may be used in conjunction with active reactant and byproduct management systems for supplying at least one of the reactants to the membrane and/or assisting in transporting at least one of the byproducts away from the membrane.

In accordance with another aspect of the invention, a metallic component may be fabricated from a metal with a rough texture and/or an expanded structure which provides a path for the fuel mixture and oxidizing agent to be introduced to the PCM, and allowing the byproducts of the reaction to move away from the PCM after the desired reactions take place.

In accordance with another aspect of the invention, the metallic component is fashioned as both a diffusion layer and a flow field plate. This structure may be employed as to one or both diffusion layers as desired or necessary for a particular application. In this embodiment, the layer component acts to both diffuse the chemical substances to and from the reactive sites on the PCM and to control the overall flow of reactants and byproducts of the reaction, thus limiting the potential for saturation of the PCM. This includes dispersing the fuel mixture to the anode face of the PCM, and dispersing oxygen to the cathodic face of the PCM, as well as to allow unreacted methanol and carbon dioxide and other by products (on the anode side) to travel away from the anode face of the PCM, allowing water to travel away from the reactive sites on the cathode face of the PCM. Not only do the metallic components allow the reactants and byproducts to travel to and from the PCM, but the layer components also, by virtue of being metallic, serve as electron conductors (or collectors). The layer components in this embodiment are connected to the external circuit from which the electricity produced by the cell is drawn.

The metallic layer components of the present invention may be employed in many configurations of direct oxidation fuel cell systems including, but not limited to single cell designs, stacked configurations, monopolar designs, or an air breathing cell system.

### BRIEF DESCRIPTION OF THE DRAWINGS

The invention description below refers to the accompanying drawings, of which:

FIG. 1 is a block diagram of a direct oxidation fuel cell system with which the diffusion layers of the present invention may be employed;

FIG. 2 is a cross-section of a direct oxidation fuel cell including the membrane electrode assembly and metallic diffusion plates of the present invention;

FIG. 2A is an isometric view of a flow field plate;

FIG. 3A is a partial cross-section of a membrane electrode assembly and the metallic diffusion layers having pores in accordance with the present invention;

FIG. 3B is a top plan view of embodiment of FIG. 3A;

FIG. 3C is an enlarged view of a portion of one embodiment of the plate having varying pore sizes;

FIG. 3D is a cross section of a combined diffusion layer and flow field plate fabricated using particle diffusion bonding techniques, with a portion of the figure exploded and enlarged;

FIG. 3E is a partial cross section of a diffusion layer fabricated in accordance with the invention to have some hydrophobic sections and some hydrophilic sections;

FIG. 4A is a partial cross-section of a membrane electrode assembly and the porous metallic diffusion layer of the present invention;

FIG. 4B is a top plan view of the embodiment of FIG. 4A;

FIG. 5 is a schematic cross section of a direct oxidation fuel cell and flow field plates in accordance with the present invention;

FIG. 6 is a schematic cross section of a bipolar stack cell configuration;

FIG. 7 is a schematic cross section of a direct oxidation fuel cell that employs a metallic diffusion layer of the invention;

FIG. 7A is a schematic cross section of a bipolar stack fuel cell assembly; and

FIG. 8 is a schematic cross section of a direct oxidation fuel cell that employs a single layer as a diffusion plate and a flow field plate in accordance with the present invention and which shows the dimensions of each of the components.

### DETAILED DESCRIPTION OF AN ILLUSTRATIVE EMBODIMENT

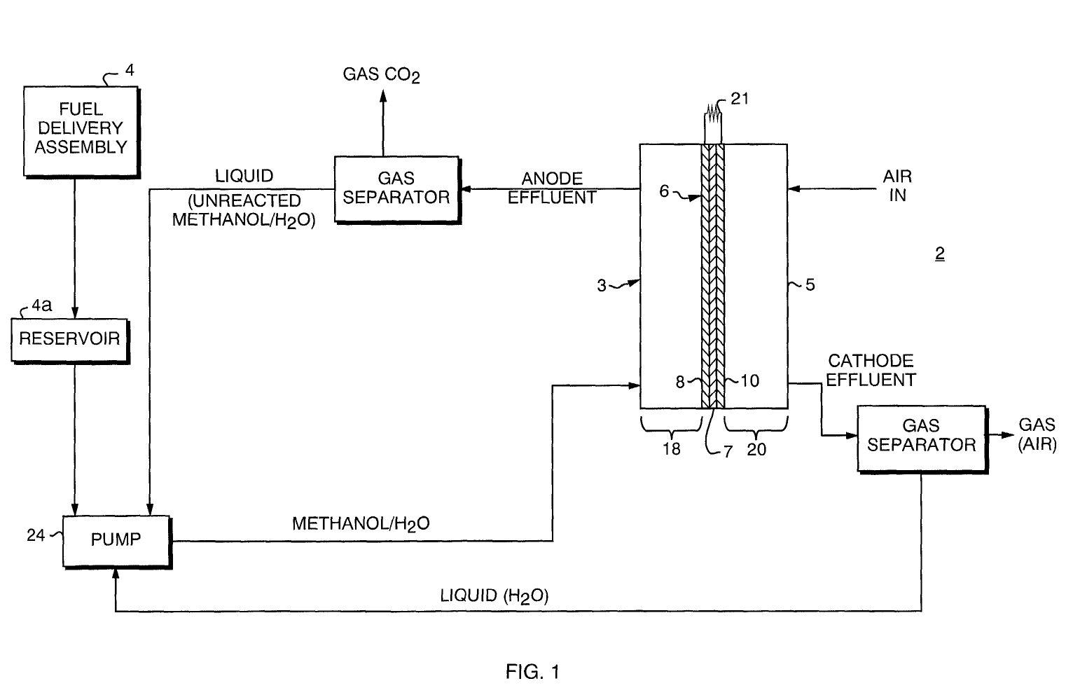

For a better understanding of the invention, the components of a direct oxidation fuel cell system, a direct oxidation fuel cell and the basic operation of a fuel cell system, will be briefly described. A direct oxidation fuel system 2 is illustrated in FIG. 1. The fuel cell system 2 includes a direct oxidation fuel cell, which may be a direct methanol fuel cell 3 (“DMFC”), for example. For purposes of illustration we herein describe an illustrative embodiment of the invention with DMFC 3, with the fuel substance being methanol or an aqueous methanol solution. It should be understood, however, that it is within the scope of the present invention that other fuels may be used in an appropriate fuel cell. Thus, as used herein, the word “fuel” shall include methanol, ethanol, propane, butane or combinations thereof and aqueous solutions thereof, and other hydrocarbon fuels amenable to use in direct oxidation fuel cell systems.

The system 2, including the DMFC 3, has a fuel delivery system to deliver fuel from fuel source 4 (reservoir 4a may be utilized, but is not necessary for operation of the DMFC system). The DMFC 3 includes a housing 5 that encloses a membrane electrode assembly 6 (MEA). MEA 6 incorporates protonically conductive, electronically nonconductive membrane 7. PCM 7 has an anode face 8 and cathode face 10, each of which may be coated with a catalyst, including but not limited to platinum or a blend of platinum and ruthenium. The portion of DMFC 3 defined by the housing 5 and the anode face of the PCM is referred to herein as the anode chamber 18. The portion of DMFC 3 defined by the housing and the cathode fact of the PCM the cathode side is referred to herein as the cathode chamber 20. Additional elements of the direct methanol fuel cell system such as flow field plates, and diffusion layers (not shown in FIG. 1) to manage reactants and byproducts may be included within anode chamber 18 and cathode chamber 20.

As will be understood by those skilled in the art, electricity-generating reactions occur when a fuel substance is introduced to the anode face of the PCM 8, and oxygen, usually in the form of ambient air, is introduced to the cathode face of the PCM 10. More specifically, a carbonaceous fuel substance from fuel source 4 (via reservoir 4a) is delivered by pump 24 to the anode chamber 18 of the DMFC 3. The fuel mixture passes through channels in the flow field plate, and/or a diffusion layer, and is ultimately presented to the PCM. Catalysts on the membrane surface (or which are otherwise present on the membrane surface) enable the direct oxidation of the carbonaceous fuel on the anode face of the PCM 8 separating hydrogen protons and electrons from the fuel and water molecules of the fuel mixture. Upon the closing of a circuit, the protons pass PCM 7, which is impermeable to the electrons. The electrons thus seek a different path to reunite with the protons, and travel through a load 21 of an external circuit, thus providing electrical power to the load. So long as the reactions continue, a current is maintained through the external circuit. Direct oxidation fuel cells produce water (H₂O), carbon dioxide CO₂ as byproducts of the reaction.

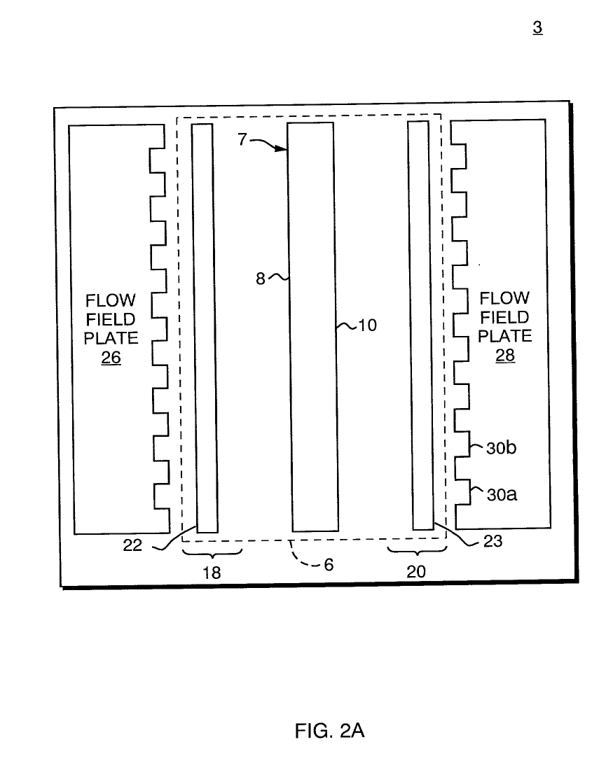

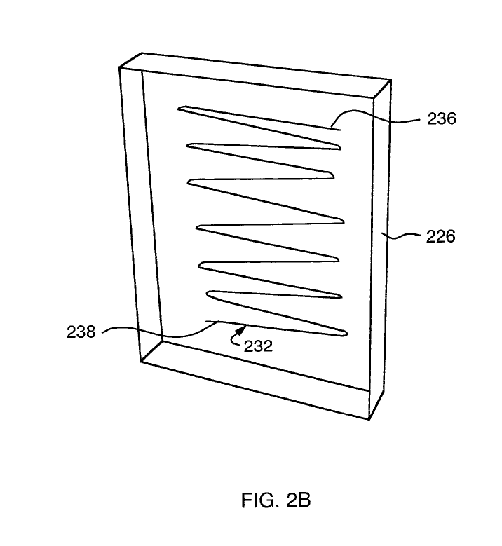

More specifically, and referring to FIG. 2 which shows fuel cell 3 in exploded form, the membrane electrode assembly 6 (sometimes referred to herein as MEA) includes the centrally disposed, protonically-conductive membrane (PCM) 7, which is impermeable to electrons, an anode diffusion layer 22 and a cathode diffusion layer 23. The PCM 7 is composed of a suitable material, such as perfluorovinylether sulfonic acid (which is commercially available as NAFION, a registered trademark of E.I. Dupont, de Nemours and Company). Anode face of PCM 8 is in contact with anode diffusion layer 22. Anode diffusion layer 22 is similarly in contact with anode flow field plate 26. Cathode face of PCM 10 is in contact with cathode diffusion layer 24. Cathode diffusion layer 24 is in contact with cathode flow field plate 28.As noted above the various components of the fuel cell are in well defined contact with one another to promote electrical conductivity

As will be understood by those skilled in the art, a carbonaceous fuel in an aqueous solution (typically an aqueous methanol solution) passes from a fuel source, through the flow field channels defined by the anode flow field plate 26, (FIG. 2) where it enters the anode diffusion layer where it is dispersed and presented to the anode face 8 of the PCM 7. Similarly, an oxidizing agent (or oxidant), preferably ambient air is made available to the PCM by passing through the flow field channels in the cathode flow field plate 28, and are dispersed by the cathode diffusion layer 24. Catalysts (not shown in FIG. 2) on the PCM 7 (or are otherwise present in each of the anode and cathode chambers, 18 and 20 respectively) enable the oxidation of the carbonaceous fuel and water mixture on the anode face of the PCM 8 forming carbon dioxide as an anodic byproduct of the reaction, and releasing protons and electrons from the hydrogen atoms in the fuel and water mixture. Upon the closing of an external circuit (shown in subsequent figures), the protons pass through the PCM 7, which is impermeable to the electrons. The electrons seek a different path to re-unite with the protons and travel through a load and, thus, provide the electrical power from the fuel cell 3. The electrochemical reaction equations are as follows:

Anode: CH₃OH+H₂O=CO₂+6H⁺+6e⁻ Equation 1

Cathode: 6H⁺+6e⁻+3/2O₂=3H₂O Equation 2

Net Process: CH₃OH+3/2O₂=CO₂2H₂O Equation 3

The reaction at the anode face of the PCM 8 of the direct oxidation fuel cell 3, as shown in Equation 1, produces carbon dioxide (CO₂). Water is produced at the cathode face of the PCM 10, as indicated in Equation 2. The net process is as set forth in Equation 3. At the cathode face of the PCM 10, oxygen (usually from ambient air) combines with protons that have migrated through PCM 7, and electrons passed through a load, to form water on the cathode face of the PCM. Each of the byproducts, water and carbon dioxide, may be vented to the ambient environment or retained for use within the DMFC system.

These reactions occur on the PCM 7 at each of the numerous reactive sites at the catalyst surface, where the fuel mixture contacts the electrolyte in the presence of catalysts and reacts to release electrons and protons from the fuel and water. Thus, in order to achieve maximum power output of the DMFC system, it is desirable to maximize the reactants' contact with the active portions of anode and cathode faces of PCM, 8 and 10 respectively. In order to achieve this and to optimize results in power production and fuel efficiency of the fuel cell 3, the introduction of the aqueous fuel to the PCM 7 is controlled by a combination of flow field plates and diffusion layers

In accordance with the present invention, the composition of the diffusion layer 22 is substantially metallic. Preferably, the metallic anodic diffusion layer 22 is fabricated from stainless steel, titanium or other metal or alloy that will not interfere with the reactions that generate electricity. The metallic anode diffusion layer 22 distributes the fuel mixture to the membrane electrode assembly in an even controlled fashion and prevents the fuel from saturating the PCM 7. By preventing saturation of the PCM and the problems associated with such saturation, namely methanol crossover and water carry-over, which inhibit the efficiency of fuel cell 3, the overall effectiveness of the fuel cell is enhanced.

Similarly, a cathode diffusion layer 24 is placed generally parallel to the cathode 10. In accordance with the present invention, the cathode diffusion layer 24 is preferably fabricated from metals that resist oxidation such as, for example, but not limited to the following: nickel, copper, steel and alloys with suitable properties for use in a direct oxidation fuel cell.

In addition to the diffusion layers, the fuel cell 3 illustrated in FIG. 2 also includes flow field plates 26 and 28. The anode flow field plate 26 is in contact with the anodic diffusion layer which in turn is in contact with the anodic face of the PCM 8. Cathode flow field plate 28 is in contact with the cathodic diffusion layer which in turn is in contact with the cathodic face of the PCM 10, as shown in FIG. 2.

In order to introduce fuel from the fuel source or reservoir to the anode diffusion layer 22 of the fuel cell 3 and to introduce oxygen (usually in the form of ambient air) to the cathode diffusion layer 24 of the fuel cell 3, anode and cathode flow field plates 26 and 28, respectively, are used. The flow field plate is typically a conductive plate having flow field channels formed or fashioned in its surface. The channels may, for example, be grooves which are precisely machined, cast, stamped, or otherwise positioned in the respective flow field plate, 26 or 28. The pattern of the grooves is typically complex, and often serpentine in nature as schematically illustrated in FIG. 2A.

FIG. 2A is an isometric view of an illustrative flow field plate 226. The flow field plate 226 has a serpentine flow field channel 232. If the flow field plate 226 is on the anode side of a fuel cell, then unreacted aqueous methanol solution enters the flow field plate 226 at, for example, entry point 236 and travels along the flow field channel 232 in order to come in contact with the greatest surface area of diffusion layer 22 and in turn with anode face of the PCM 8. (FIG. 2) At the opposite end 238 of the flow field plate 226, the partially reacted aqueous methanol solution and carbon dioxide (a by-product of the anodic half reaction) exit the flow field plate 226 where the carbon dioxide is either vented or captured to perform work within the DMFC system before being released, and the unreacted aqueous methanol solution is returned to the anode side of the fuel cell 3. The serpentine pattern is illustrative only, and it should be understood that the grooves in the plates may be in a variety of patterns while still remaining within the scope of the present invention. The grooves formed in the flow field plate to direct the flow of liquids and gases are shown in cross section in FIG. 2 as grooves 30a, 30b of flow field plate 28, for example.

Once the reactants are introduced into the MEA 6 the diffusion layers act to disperse them evenly across the respective face of the PCM 7. The metallic diffusion layers of the present invention include openings to allow the reactants and by-products of the electricity generating reactions to be introduced to, and move away from the PCM 7 in a manner that allows the reactions to continue as desired.

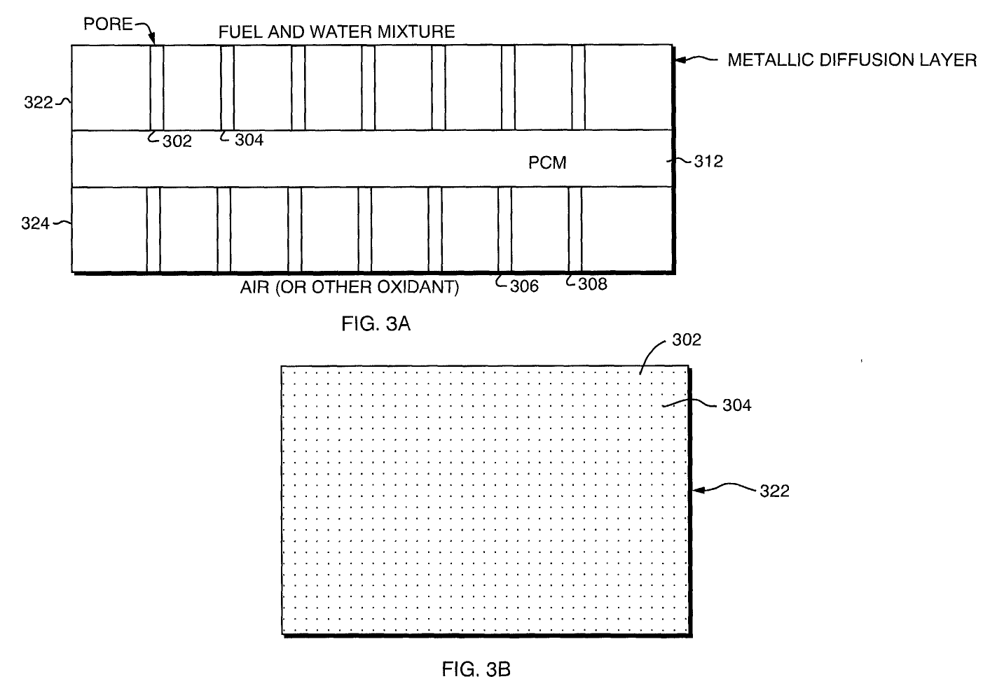

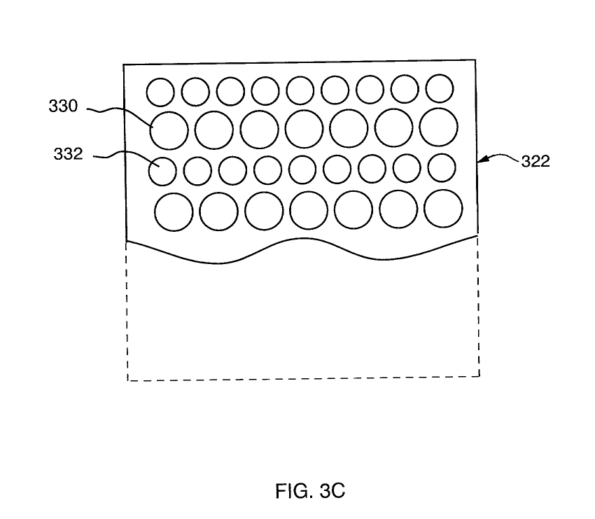

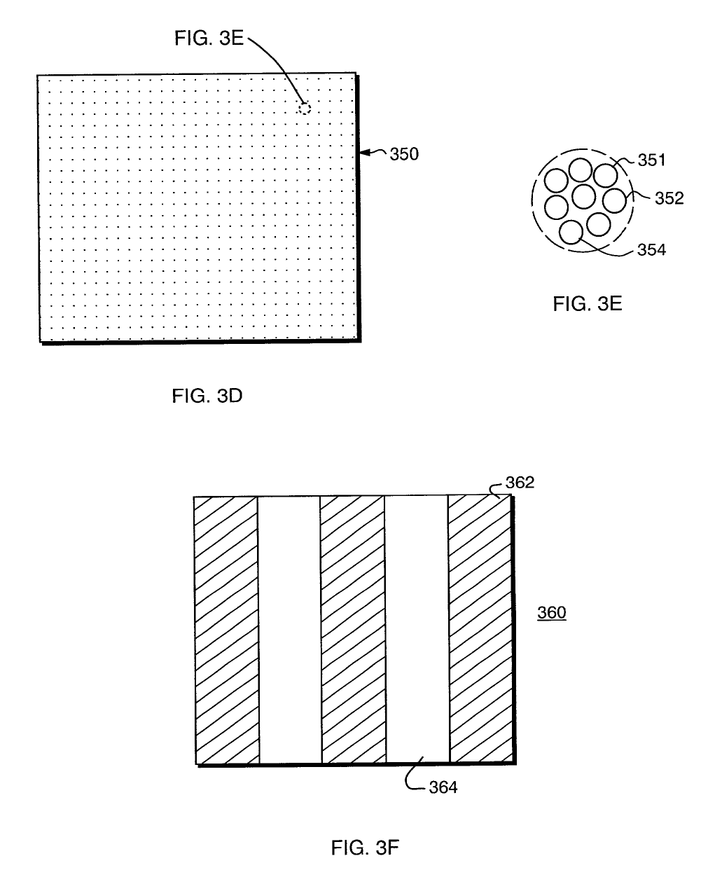

Further details of this aspect of the invention can be better understood with reference to FIGS. 3A through 3E. FIG. 3A illustrates PCM 312 and metallic diffusion layers 322 and 324 (corresponding to those that had been discussed with reference to FIGS. 1 through 2A). However, as shown in FIG. 3A, a cross section of a MEA utilizing metallic diffusion layers 322 and 324 include pores such as the pores 302, 304 and 306 and 308.

Pores 302, 304 of the metal diffusion layer 322, for example, may be machined into a metal sheet or may be produced in the process of casting the metallic diffusion layer. The pores may also be created by physically punching or perforating techniques, using laser ablation, or using other commonly understood high volume manufacturing techniques. FIG. 3B is a top view of metallic diffusion layer 322 in which the pores 302, 304 are shown as evenly distributed. The pores may also be placed in any configuration suitable for the diffusion of the fuel mixture to the anode face of the PCM 74 (FIG. 2), or for the even distribution of ambient oxygen in the form of ambient air to the cathode face of the PCM 16, and for the transport of byproducts away from the PCM 7.

Referring to FIG. 3C, a portion of the diffusion layer 322 of FIG. 3B is illustrated (with the remainder of the plate in phantom), but in which the pore sizes vary across the plate. The larger pores, such as pore 330 allow the liquid reactants and by products to pass to and away from the PCM. To further enhance this functionality, the larger pores may be treated with a hydrophilic material. The smaller pores such as pore 332 may be small enough (approx 10-40 mils) to allow for gas transport, but not for liquid transport. Furthermore, these pores can, in accordance with the invention, be treated with a hydrophobic substance to repel the aqueous solutions and allow gases to pass through, and resists water from plugging or saturating the smaller pores, while also resisting the accumulation of carbon dioxide, thus improving the operation of the PCM 7, the fuel cell 3, and the DMFC system. The hydrophobic treatment includes, but is not limited to applying a Teflon solution to the smaller pores. A hydrophilic treatment includes, but is not limited to applying a Nafion solution to the pores. Such pore distributions as illustrated in FIG. 3C are very useful for facilitating the anode and cathode reactions by creating discrete and continuous mass transport paths through the metallic component for each of the liquid reactants and byproducts, and the gaseous reactants and byproducts.

A further embodiment of the invention is illustrated in FIG. 3D. FIG. 3D shows a metallic layer component 350. This metallic layer component is fabricated of microscopic particles 351 in a technique known as particle diffusion bonding. In accordance with this technique, particles of a uniform size are heated until they near the melting point and pressed, but are bonded together, rather than melting by careful control of the temperature and pressure applied. This process causes openings that are approximately uniform in size, to be formed between the particles. The size of the openings can be controlled by varying the diameter of the particles. In accordance with this aspect of the invention, the particles may be selected of the appropriate metal for either the anode diffusion layer 22, or the cathode diffusion layer 24, and the diameter can be chosen to allow the various reactants to pass through.

It may be further desirable to treat component, such as the particle 351, with either a hydrophobic treatment, or a hydrophilic treatment depending on the desired effect. Furthermore, one sheet, such as the layer 360 of FIG. 3E, may have a pattern of some hydrophobic areas and some hydrophilic areas, in any number of desired configurations. For example, and not by way of limitation, the section designated by reference character 362 in FIG. 3E, may be hydrophobic to facilitate flow of gases such as carbon dioxide away from the PCM on the anode side and the flow of oxygen to the PCM on the cathode side. Whereas the particles section designated by reference number 364, may be treated with a hydrophilic substance to facilitate transport of the fuel mixture to the anodic face of the PCM 8 and the removal of water from the cathodic face of the PCM 10.

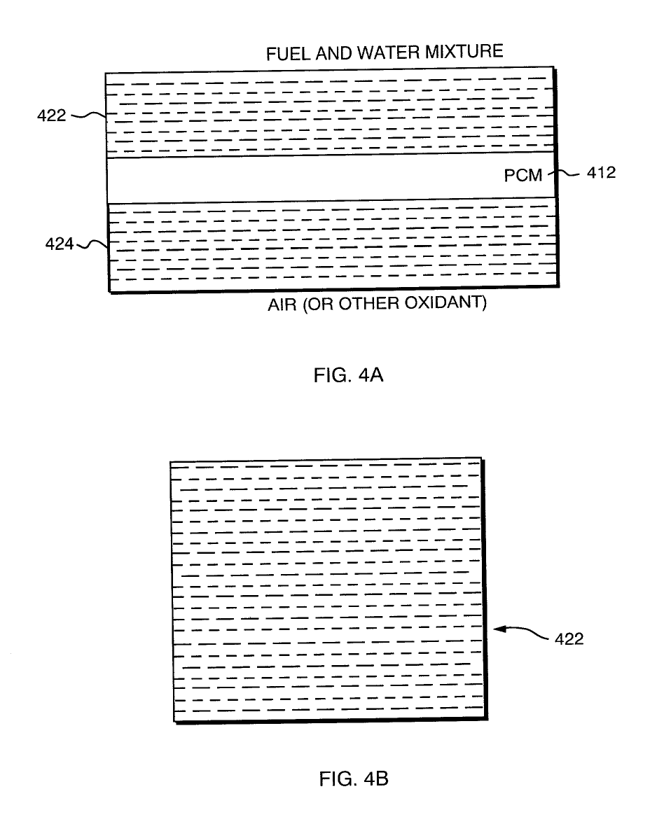

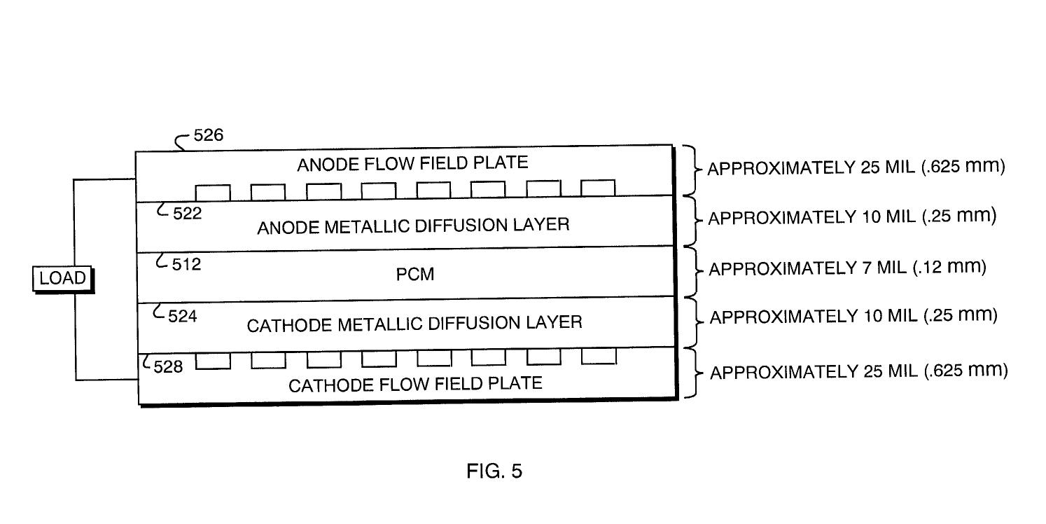

In accordance with an alternative aspect of this embodiment of the invention, a metallic diffusion layer 422, 424 (FIG. 4A) is fabricated from a metal with a rough texture and expanded structure (similar to a metallic sponge), which provides an indirect, tortuous path for the reactants to flow to the PCM 7, and the byproducts to flow from the PCM 7. More specifically, the fuel to be introduced to the anode face of PCM 8, or oxygen to be introduced to the cathode face of PCM 10 flows through the porous openings of the metallic layer 422, or 424, respectively and the carbon dioxide and evolved water flow away from the anode and cathode faces of the PCM respectively. The porous metal diffusion layers shown in FIGS. 4A and 4B may be loaded with Teflon so that each diffusion layer as a whole is hydrophobic, thus facilitating the release of gaseous reactants and byproducts. Alternatively, the metallic component may be selectively loaded with Teflon to create areas of relative hydrophobicity and hydrophilicity as described in FIG. 3E. By doing so, the hydrophobic areas 362 will act to transport gaseous reactants and byproducts from PCM 7, whereas the comparatively hydrophilic areas 364 will facilitate the transport of liquid reactants.

These embodiments of the invention allow for versatility in selecting materials and functionality for particular fuel cells and applications while allowing manufacturing techniques which are feasible on a large scale for commercial production. Furthermore, in the embodiment shown in FIG. 2, as noted herein, the anode diffusion layer 22 is preferably comprised of stainless steel, titanium or other chemically inert metal. The metal does not absorb or react with methanol or other fuel, and thus does not interfere with the completion of the electricity-generating reactions. Nor does the invention become saturated over time, as is the case with conventionally employed carbon paper and carbon cloth diffusion layers. Thus, the inventive metallic diffusion layers allow for a more robust fuel cell. Moreover, the carbon paper and carbon cloth presently employed also tend to shrink over time and to varying degrees, depending on the particular characteristics of each piece of material. This often makes it difficult to precisely cut or fabricate a diffusion layer with predictable characteristics. In contrast, the expansion contraction co-efficient of metallic compounds are generally well known, making it easier to fabricate properly sized diffusion layers such as the diffusion layers 22 and 24 of FIG. 1. Commercial volume manufacturing and handling techniques for metal are generally better established than methods for working with carbon paper, and are better suited for working with robust materials (such as metals) than brittle or fragile materials (such as carbon paper or carbon impregnated cloth). Thus, forming diffusion layers in accordance with the present invention in commercial quantities will be easier and more consistent and predictable, and will result in more consistent production of high quality diffusion layers.

A further advantage of the present invention relates to the savings in the size of the overall cell. As noted, direct oxidation fuel cells are being explored as power supply options for small, hand held electronics. Thus, form factors and space constraints are a challenge. The metallic diffusion layers of the present invention are no thicker than carbon paper or carbon cloth diffusion layers. The metallic diffusion layer may be approximately 10 mil (0.25 mm) thick whereas the stack of carbon paper sheets would be between 10 and 25 mils (0.25-0.625 mm) thick. This aspect of the invention may be better understood with reference to FIG. 5. The anodic flow of field plate 526 has approximately a 25-40 mil (0.625 mm) thickness. The anodic metal diffusion layer 522 is approximately 10 mil (0.25 mm) thick. The PCM 512 is approximately 7 mils (0.12 mm) thick, the cathode metallic diffusion layer 524 is approximately 10 mils (0.25 mm) thick, and the cathode flow field plate 528 is approximately 25 mils (0.625 mm) thick. The total thickness of the basic cell components together is approximately 77 mils. The thickness of a typical diffusion layer, which includes carbon paper, would be between about 10 and 25 mils, for a total fuel cell thickness of between 77 and 107 mils. Thus, a savings of up to 30 mils is provided by the metallic diffusion layers of the invention, when used as a substitute for carbon paper or carbon cloth diffusion layers.

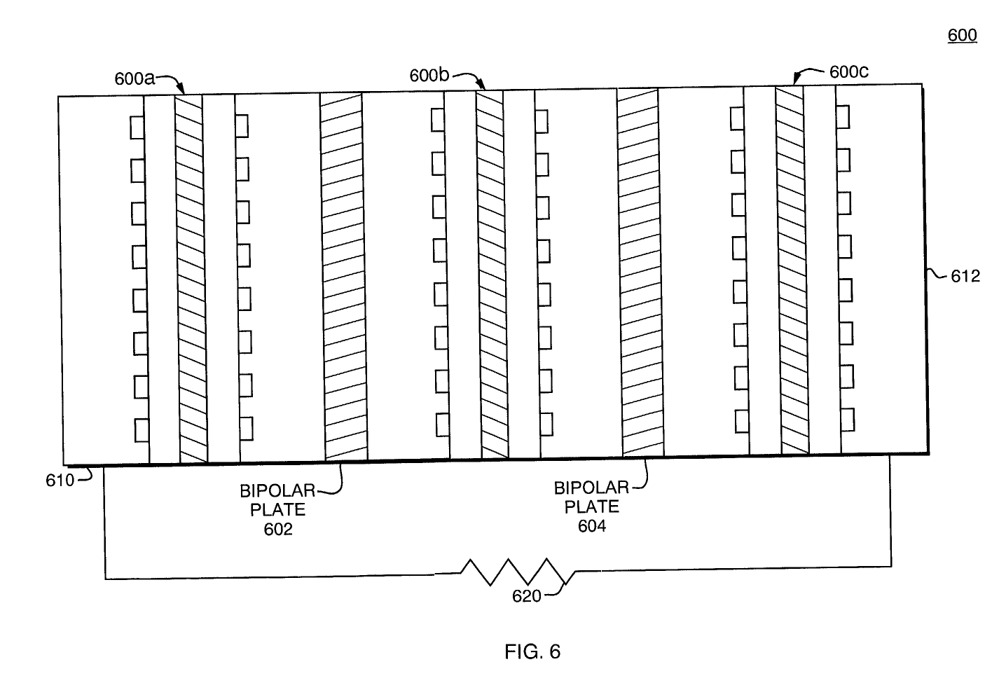

This advantage is particularly relevant in the case of a bipolar stack configuration. A bipolar stack 600 is illustrated in FIG. 6. The embodiment of FIG. 6 illustrates a stack of three cells 600a, 600b and 600c. The cells have the same architecture as that already described with reference to FIG. 2, but they are coupled via bipolar plates 602 and 604. The bipolar plates serve to load electrons on to the next cell. The outer flow field plates 610 and 612 are used to connect the load 620 of the external circuit. This is a conventional architecture used to provide increased voltage while remaining within required form factors. Three cells are shown in the stack 600 of FIG. 6, however, the invention is equally applicable to stacks having a different number of cells. The present invention allows the stack to be much thinner in that each cell has smaller dimensions than conventional cells, as just described with reference to FIG. 5. Further such cells typically require active air management and for fuel to be pumped into each anode chamber of each cell. Thus, the embodiment of the invention in which the metallic layers are fashioned with hydrophobic and hydrophilic portions are particularly advantageous to further assist in the control of liquid and gas flow and transport.

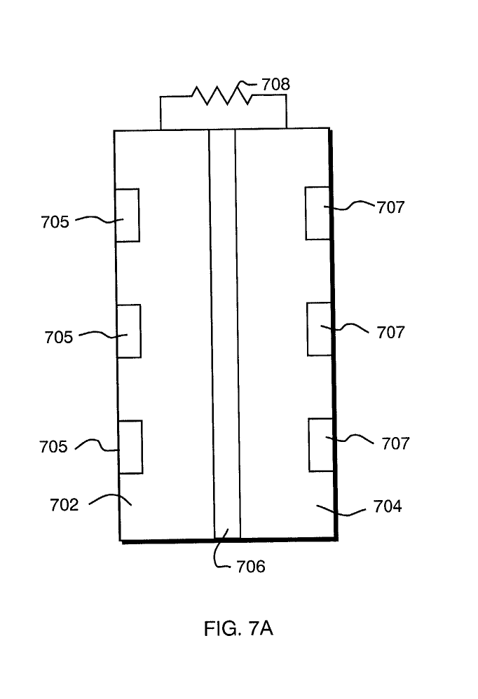

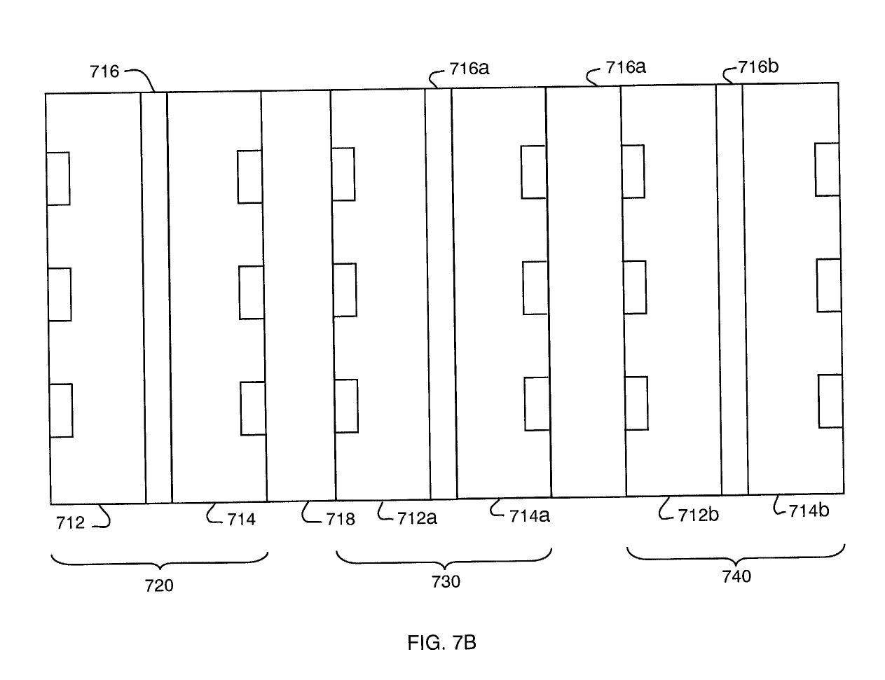

Another embodiment of the invention allows a single metallic component to perform the functions typically provided by a diffusion layer and a flow field plate. This embodiment is illustrated in FIG. 7. In FIG. 7, a PCM 12 is disposed between anodic metallic component 702 and cathodic metallic component 704. Anodic metallic component 702 and cathodic metallic components are fabricated in such a manner as to allow reactants to flow through anode and cathode channels 705, and 707, respectively to control the flow of such reactants. Reactants and byproducts are diffused, through anode and cathode components 702 and 704 respectively. As with present MEAs, each of the components is in close contact with PCM 706. In addition, hydrophobic and hydrophilic treatments of the components may occur in accordance with those set forth above. Use of the metallic component, is very similar to the use of discrete flow field plates and diffusion layers as is presently done.

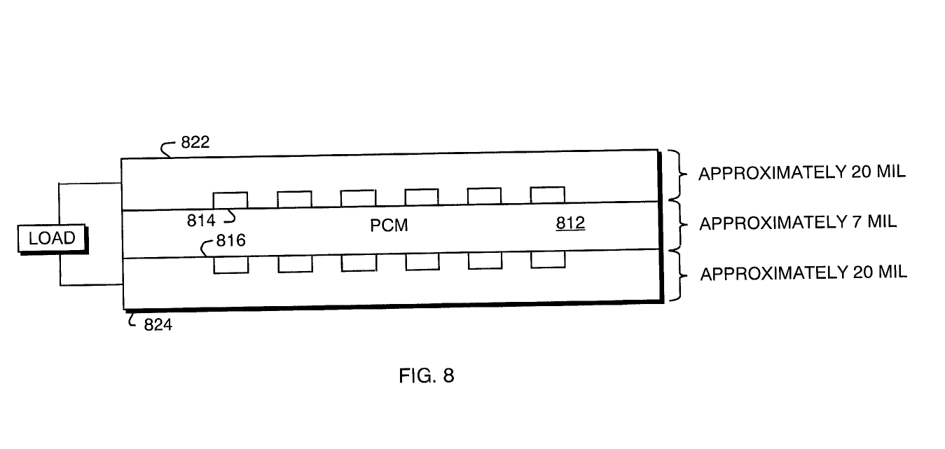

Most direct oxidation fuel cell designs rely on flow of field plates to assist not only in the bulk management of fluid and gases within the fuel cell but also to connect the load for the external circuit through which the electrons flow. Thus, the metallic components 702 and 704 of FIG. 8 also act as the current collector plates, and connect the circuit connected by load 708.

A stack utilizing the inventive design is shown in FIG. 7A. In the stack, functions of present flow field plates and diffusion layers are combined. The stack shown in FIG. 7A consists of three cells 720, 730, 740 respectively. Each cell consists of a PCM 716, 716A, and 716B, disposed between an anode metallic component 712, 712A, and 712B, respectively into which a fuel mixture is fed, and a cathode metallic component, 714, 714A and 714B into which oxygen is introduced. Cells are separated by bipolar plates, 718 and 718A. The metallic components and bipolar plates are bonded together prior to assembly of the direct methanol fuel cell in order to minimize interfacial electrical resistance and decrease the number of parts required for assembly. Each of the stacks is functionally similar to stacks that contain discrete diffusion layers and flow field plates, and will function in a manner that is similar to that shown in FIG. 6. This embodiment will be a particularly attractive when space constraints are a factor in that the number of over-all components are reduced, and this can have particular advantages in a stacked cell. Furthermore, use of fewer components also reduces interface losses, thus leading to greater efficiency of the stack and system. And moreover, the combined layer component would also result in fewer components to be manufactured, thus reducing manufacturing and assembly costs. In addition to a stacked configuration, other configurations of fuel cells such as monoplanar cells, air breather cells, and many other configurations may incorporate the metallic layer components of the present invention. Further, depending upon the particular application for which the cell is used, it may be that one flow field plate is retained in a particular application depending upon the operating characteristics of the device being powered by the fuel cell

As shown in FIG. 8, the anode metallic component 822 has a thickness of approximately 20 mils, the PCM 812 has a thickness of approximately 7 mils and the cathode metallic diffusion layer 824 has a thickness of approximately 20 mils. As such the thickness of the assembly is approximately 47 mils. This is a thickness saving of approximately 60 mils over assemblies that use both flow field plates and diffusion layers as opposed to metallic component 822. Because of the need to meet with rigid form functions, the lower volume is of great benefit. As with conventional flow field plates flow field channels may also be machined into the diffusion layer similar to those machined in to the flow field plates, if desired for a particular application. Alternatively, the diffusion layer and flow field can be formed in a single process , such as particle diffusion bonding, from metallic particles of desired size in order to control the porosity of the components.

In addition to the other advantages of the present invention already outlined, the metallic component of the present invention may provide improved structural integrity to the housing of the fuel cell. In addition because the metal is malleable, it can be molded to fit almost any configuration including those where a curved surface, or a surface with multiple planar faces is desirable. This may be critical to developing fuel cells that can be used in portable electronic devices, which require that they be manufactured in a variety of form factors. Due to the metal's greater strength compared to carbon paper and carbon cloth, it is possible to introduce fluids at a higher pressure with a metallic diffusion layer than with carbon paper or carbon cloth. Typically, carbon paper and carbon diffusion layers are compromised at approximately 15 PSI, where as a metallic diffusion layer will retain its structural integrity until approximately 50 PSI. This will allow for faster mixing of reactants within the fuel cell, as well as an increased range of operating conditions. Furthermore, a properly selected metal will improve the conductivity of the electrons as compared to carbon cloth or carbon paper, which are not capable of conducting electrons as efficiently as metals.

It should be understood that the metallic diffusion layers of the present invention provide a number of advantages over the previously used carbon paper and carbon cloth layers. These advantages include the feature that the metallic diffusion layers will not become saturated over time, which thus provides a more robust fuel cell system. The metallic diffusion layers are easier to manufacture and handle and thus are more amenable to mass production on a large scale than separate sheets of carbon paper. The metallic diffusion layers are thinner and malleable and can, thus be molded to fit configurations which are needed for portable electronics, which must be manufactured in a variety of form factors. Higher pressure may be used to introduce the reactants to the fuel cell utilizing the metallic diffusion layers, allowing for increased flow rates within the system.

Furthermore, the combined diffusion layer/flow field plate metallic component reduces the number of elements in the fuel cell, and as a whole to takes up less space, reduces interface losses. In addition, the components of the invention are versatile in that they may be used in a variety of systems. Thus, it should be understood that the metallic diffusion layers of the present invention for use with the direct oxidation fuel cell provide many advantages.

The foregoing description has been directed to specific embodiments of the invention. It will be apparent however, that other variations and other modifications may be made to the described embodiments, with the attainment of some or all of the advantages of such. Therefore, it is the object of the appended claims to cover all such variations and modifications as come within the true spirit and scope of the invention.

What is claimed is:

1. A direct oxidation fuel cell, comprising:
(A) a membrane electrode assembly, including:
(i) a protonically conductive, electronically non-conductive membrane electrolyte having an anode face and an opposing cathode face; and
(ii) a catalyst coating disposed upon each of said anode face and said cathode face, whereby electricity-generating reactions occur upon introduction of an associated fuel including anodic disassociation of said fuel into carbon dioxide, protons and electrons, and a cathodic combination of protons, electrons and oxygen from an associated source of oxygen, producing water; and
(B) an anodic metallic diffusion layer disposed generally parallel to said anode face of said membrane electrode assembly and having a plurality of openings therein to allow said associated fuel mixture to pass therethrough to said anode face of said membrane electrode assembly to a contact point on said membrane to produce said electricity generating reaction, and to allow free electrons and carbon dioxide produced in said reactions to return back away from said membrane electrode assembly, and to allow unreacted fuel to return back from said membrane electrode assembly;
(C) a cathodic metallic diffusion layer disposed generally parallel to said cathode face of said membrane electrode assembly and having a plurality of openings therein to allow oxygen to pass there-through to said cathode face of said membrane electrode assembly and protons, electrons and water to pass back away from said membrane electrode assembly; and
(D) a load coupled across said fuel cell providing a path for said free electrons produced in said electricity-generating reactions.

2. The direct oxidation fuel cell as defined in claim 1 wherein
said openings in at least one of said anodic metallic diffusion layer and said cathodic metallic diffusion layer comprise a plurality of pores formed in said metallic diffusion layer.

3. The direct oxidation fuel cell as defined in claim 1 wherein
at least one of said anode metallic diffusion layer and said cathode metallic diffusion layer comprise a porous metal that has said openings therein that allow substances to pass through said openings.

4. The direct oxidation fuel cell as defined in claim 1 wherein
said anodic metallic diffusion layer is comprised of stainless steel.

5. The direct oxidation fuel cell as defined in claim 1 wherein
said cathodic metallic diffusion layer is comprised of a material selected from the group consisting of nickel, copper, steel and combinations thereof.

6. The direct oxidation fuel cell as defined in claim 1 wherein
at least one of said anode metallic diffusion layer and said cathode metallic diffusion layer comprises a composition of loose pieces of metal that have spaces therebetween allowing substances to pass between the interstices of said metal pieces.

7. The direct oxidation fuel cell as defined in claim 1 further comprising
a first flow field plate disposed parallel to said anode metallic diffusion layer;
a second flow field plate disposed parallel said cathode metallic diffusion layer;
each of said flow field plates having grooves formed therein to direct the flow of substances within said fuel cell most efficiently across its respective metallic diffusion layer; and
a load connected between said first flow field plate and said second flow field plate to form an electrical circuit external to said fuel to extract electrons, and thus electricity, from said fuel cell.

8. The direct oxidation fuel cell as defined in claim 1 wherein
said anode metallic diffusion layer performs as a flow field plate to conduct electrons produced in said electricity generating reactions and said load being connected at one end to said anode metallic diffusion layer to provide a path for said electrons out of said fuel cell as the electricity produced by said fuel cell.

9. The direct oxidation fuel cell as defined in claim 1 wherein
said cathode metallic diffusion layer performs as a flow field plate to reunite electrons with protons that pass through said membrane and said load being attached at one end to said cathode metallic diffusion layer to reunite said electrons with said protons and reacting with oxygen at said cathode side of said fuel cell thus producing water.

10. The direct oxidation fuel cell as defined in claim 8 wherein
said anode metallic diffusion layer performing as said flow field plate includes grooves formed therein to direct the flow of fuel to said anode face of said membrane electrode assembly.

11. The direct oxidation fuel cell as defined in claim 9 wherein
said cathode metallic diffusion layer performing as said flow field plate has grooves formed therein to direct the flow of said oxygen across the cathode face of said membrane electrode assembly.

12. The direct oxidation fuel cell as defined in claim 1 wherein
said fuel is selected from the group consisting of methanol, ethanol, propane, butane and aqueous solutions thereof, and combinations thereof.

13. A direct oxidation fuel cell system, comprising:
(A) a direct oxidation fuel cell including an anode, a cathode, and a membrane electrolyte disposed between the anode and the cathode;
(B) a source of fuel;
(C) a source of oxygen coupled to said cathode so as to produce electricity-generating reactions including anodic disassociation of said fuel to produce carbon dioxide, protons and electrons and a cathodic combination of protons, electrons and oxygen producing water;
(D) a gas separator coupled to receive said carbon dioxide produced at said anode;
(E) an anodic metallic diffusion layer disposed generally parallel to said anode face of said membrane electrode assembly and having a plurality of openings therein to allow said associated fuel mixture to pass therethrough to said anode face of said membrane electrode assembly to a contact point on said membrane to produce said electricity generating reaction, and to allow free electrons and carbon dioxide produced in said reactions to return back away from said membrane electrode assembly, and to allow unreacted fuel to return back from said membrane electrode assembly;
(F) a cathodic metallic diffusion layer disposed generally parallel to said cathode face of said membrane electrode assembly and having a plurality of openings therein to allow oxygen to pass there-through to said cathode face of said membrane electrode assembly and protons, electrons and water to pass back away from said membrane electrode assembly; and
(G) a load coupled across said fuel cell providing a path for said free electrons produced in said electricity-generating reactions.

14. The direct oxidation fuel cell system as defined in claim 13 wherein said openings in at least one of said anodic metallic diffusion layer and said cathodic metallic diffusion layer comprise a plurality of pores formed in said metallic diffusion layer.

15. The direct oxidation fuel cell system as defined in claim 13 wherein
at least one of said anode metallic diffusion layer and said cathode metallic diffusion layer comprise a porous metal that has said openings therein that allow substances to pass through said openings.

16. The direct oxidation fuel cell system as defined in claim 13 wherein
at least one of said anode metallic diffusion layer and said cathode metallic diffusion layer comprises a composition of loose pieces of metal that have spaces therebetween allowing substances to pass between the interstices of said metal pieces.

17. The direct oxidation fuel cell system as defined in claim 13 further comprising:
a first flow field plate disposed parallel to said anode metallic diffusion layer;
a second flow field plate disposed parallel said cathode metallic diffusion layer;
each of said flow field plates having grooves formed therein to direct the flow of substances within said fuel cell most efficiently across its respective metallic diffusion layer; and
a load connected between said first flow field plate and said second flow field plate to form an electrical circuit external to said fuel to extract electrons, and thus electricity, from said fuel cell.

18. The direct oxidation fuel cell system as defined in claim 13 wherein
said anode metallic diffusion layer performs as a flow field plate to conduct electrons produced in said electricity generating reactions and said load being connected at one end to said anode metallic diffusion layer to provide a path for said electrons out of said fuel cell as the electricity produced by said fuel cell.

19. The direct oxidation fuel cell system as defined in claim 13 wherein
said cathode metallic diffusion layer performs as a flow field plate to reunite electrons with protons that pass through said membrane and said load being attached at one end to said cathode metallic diffusion layer to reunite said electrons with said protons and reacting with oxygen at said cathode side of said fuel cell thus producing water.

20. The direct oxidation fuel cell system as defined in claim 13 wherein
said anode metallic diffusion layer performing as said flow field plate includes grooves formed therein to direct the flow of fuel to said anode face of said membrane electrode assembly.

21. The direct oxidation fuel cell system as defined in claim 13 wherein
said cathode metallic diffusion layer performing as said flow field plate has grooves formed therein to direct the flow of said oxygen across the cathode face of said membrane electrode assembly.

22. The direct oxidation fuel cell system as defined in claim 13 wherein
said fuel is selected from the group consisting of methanol, ethanol, propane, butane and aqueous solutions thereof, and combinations thereof.

23. A direct oxidation fuel cell system comprising:
(A) a direct oxidation fuel cell means including an anode, a cathode, and a protonically conductive, electronically non-conductive membrane electrolyte disposed between the anode and the cathode;
(B) means for providing oxygen coupled to said cathode so as to produce electricity-generating reactions including anodic disassociation of a fuel and water mixture to produce carbon dioxide, protons and electrons and a cathodic combination of protons, electrons and oxygen producing water;
(C) means for providing a fuel and water mixture to said fuel cell;
(D) means for distributing said fuel and water mixture generally evenly to said anode, and said means for distributing being of a substantially metallic composition; and
(E) means for distributing said oxygen generally evenly to said cathode, and said means for distributing being substantially of a metallic composition.
